(19) United States
(12) Patent Application Publication
(10) Pub. No.: US 2021/0053294 A1
(43) Pub. Date: Feb. 25, 2021

(54) MIX OF BUILD MATERIALS

(71) Applicant: HEWLETT-PACKARD DEVELOPMENT COMPANY, L.P., Spring, TX (US)

(72) Inventors: Miguel Vega Velasco, Sant Cugat del Valles (ES); Alejandro Torres Pinero, Sant Cugat del Valles (ES); Pedro Garcia Garces, Sant Cugat del Valles (ES)

(21) Appl. No.: 17/051,423

(22) PCT Filed: Sep. 26, 2018
(86) PCT No.: PCT/US2018/052989

§ 371 Date: Oct. 28, 2020

(51) Int. Cl. B29C 64/393; B29C 64/314; B33Y 40/00; B33Y 50/02

(52) U.S. Cl. CPC B29C 64/393; B33Y 50/02; B33Y 40/00; B29C 64/314

(57) ABSTRACT

An example of an apparatus is disclosed. The apparatus comprises a controller to obtain a desired quality level for an object to be printed based on an input. The controller is also to determine a ratio of a first build material and a second build material based on the desired quality level. The first build material is a higher quality build material than the second build material. The controller is further to prepare a mix of build material of the determined ratio to be used during generation of the object.

### BACKGROUND

Some additive manufacturing systems may spread additive manufacturing build material to form a build material layer and may selectively solidify portions of each layer to form a layer of an object. In one example, selective solidification may be achieved by selectively applying an energy absorbing fusing agent over each formed layer of build material and applying a fusing energy to the build material layer to cause portions thereof on which fusing agent was printed to heat up sufficiently to melt, coalesce, sinter, or otherwise fuse, and then to solidify upon cooling.

In another example, an additive manufacturing system may be a Selective Laser Sintering (SLS) system that comprises a laser which can be scanned over selected portions of each layer to selectively fuse or sinter the portions.

The quality, strength and functionality of the objects generated by the different additive manufacturing systems may vary depending on the quality of additive manufacturing build material used.

### BRIEF DESCRIPTION OF THE DRAWINGS

The present application may be more fully appreciated in connection with the following detailed description taken in conjunction with the accompanying drawings, in which like reference characters refer to like parts throughout and in which:

FIG. 1 is a schematic diagram illustrating an example of an apparatus to prepare mix of build materials.

FIG. 2 is a schematic diagram illustrating an example of another apparatus to prepare mix of build materials.

FIG. 3 is a schematic diagram illustrating an example of another apparatus to prepare mix of build materials.

FIG. 4 is a schematic diagram illustrating an example of another apparatus to prepare mix of build materials.

FIG. 5 is a schematic diagram illustrating an example of a 3D printer comprising an apparatus to prepare mix of build materials.

FIG. 6 is a flowchart of an example method for preparing a mix of build materials.

FIG. 7A is a flowchart of another example method for preparing a mix of build materials.

FIG. 7B is a flowchart of another example method for preparing a mix of build materials.

FIG. 8 is a schematic diagram illustrating an example of a processor-based system to prepare mix of build materials.

### DETAILED DESCRIPTION

The following description is directed to various examples of the disclosure. In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

In an example, additive manufacturing systems or three-dimensional (3D) printing may spread additive manufacturing build material to form a build material layer and may selectively solidify portions of each layer to form a layer of an object. In one example, selective solidification may be achieved by selectively applying an energy absorbing fusing agent over each formed layer of build material, and applying a fusing energy to the build material layer to cause portions thereof on which fusing agent was printed to heat up sufficiently to melt, coalesce, sinter, or otherwise fuse, and then to solidify upon cooling.

According to an example, a suitable fusing agent may be an ink-type formulation comprising carbon black, such as, for example, the fusing agent formulation commercially known as V1Q60A “HP fusing agent” available from HP Inc. In an example such a fusing agent may additionally comprise an infra-red light absorber. In an example such an ink may additionally comprise a near infra-red light absorber. In an example such a fusing agent may additionally comprise a visible light absorber. In an example such an ink may additionally comprise a UV light absorber. Examples of inks comprising visible light enhancers are dye based colored ink and pigment based colored ink, such as inks commercially known as CE039A and CE042A available from HP Inc.

In the present disclosure, the term “fuse” shall be understood as comprising, where appropriate, any one or more of: fuse, melt, coalesce, and sinter. For simplicity, the terms “fuse”, “fusing”, and “to fuse” may be used throughout the disclosure.

Suitable powder-based build materials for use in examples herein may include, where appropriate, at least one of polymers, crystalline plastics, semi-crystalline plastics, polyethylene (PE), polylactic acid (PLA), acrylonitrile butadiene styrene (ABS), amorphous plastics, polyvinyl alcohol plastic (PVA), polyamide, thermo(setting) plastics, resins, transparent powders, colored powders, metal powder, ceramics powder such as for example, glass particles, and/or a combination of at least two of these or other materials, wherein such combination may include different particles each of different materials, or different materials in a single compound particle. Example blended build materials include alumide, which may include a blend of aluminum and polyamide. As discussed above, some additive manufacturing systems use build material in, for example, a powdered or granular form. As described above, a suitable build material may be a powdered semi-crystalline thermoplastic material. A suitable material may be Nylon 12, which is available, for example, from Sigma-Aldrich Co. LLC. Another suitable material may be PA 2200 which is available from Electro Optical Systems EOS GmbH. According to another example, a suitable build material may be PA12 build material commercially known as V1R10A “HP PA12” available from HP Inc.

Different powders may have different characteristics, such as different average particle sizes, different minimum and maximum particle sizes, different coefficient of friction, different angle of repose, and the like. In some examples non-powdered build materials may be used such as gels, pastes, and slurries. Additionally, or alternatively from the above, in some examples build materials may be formed from, or may include, short fibres that may, for example, have been cut into short lengths from long strands or threads of material.

The build material used in an additive manufacturing process may be “fresh” build material, “recycled” build material, or a mix of fresh and recycled build material. Fresh build material should be considered to be build material which has not been used in any part of an additive manufacturing process, and/or which has not passed through any part of the 3D printing system previously. Recycled build material may be considered as build material that has already been supplied to a 3D printing system for use in an additive manufacturing process. Not all of the build material supplied to a 3D printing system for use in additive manufacturing process may be incorporated into a 3D printed article. At least some of the unused build material supplied to a 3D printing system for use in an additive manufacturing process may be suitable for reuse in a subsequent additive manufacturing process. Some build material may be reused in multiple 3D printing processes. However, with each re-use the build material may experience significant heating, followed by cooling, and each cycle of heating and cooling may degrade some of the material properties of some types of build material. Degradation may include, for example, degradation of strength properties of an object made with such build material. These cycles are referred hereinafter as “recycling cycles”. Therefore, recycled build material may lead to objects being generated that have degraded properties compared to an object generated using fresh build material.

The ability to use recycled build material to generate 3D objects helps reduce the cost of object generation using 3D printing techniques. However, care needs to be taken to ensure that the quality of printed objects is consistent with the intended object quality.

A mix of build materials, when mixed, may also be known as batch. In some examples of three-dimensional printers, a premixed batch of build materials is prepared and stored to be used by the 3D printer to generate an object. In other examples of three-dimensional printers, the batch is not premixed, but is prepared at substantially the same time the printing operation is performed. In an example, a batch of build material may comprise a mix of about an 80% of recycled powder and about a 20% of fresh powder. In another example, a batch of build material may comprise a mix of about a 75% of recycled build material and about a 25% of fresh build material. In another example, a batch of build material may comprise a mix of about a 50% of recycled build material and about a 50% of fresh build material. In another example, a batch of build material may comprise a mix of about a 25% of recycled build material and about a 75% of fresh build material. In another example, a batch of build material may comprise substantially a 100% of fresh build material. In yet another example, a batch of build material may comprise substantially a 100% of recycled build material.

As mentioned above, the quality, strength and functionality of the objects generated by the different additive manufacturing systems may vary depending on the quality of additive manufacturing build material used. Therefore, the resulting quality of the mix of recycled build material and fresh build material may determine the final quality of the printed part. Determining the appropriate mix of fresh build material and recycled build material may suppose a challenge. From the one side using fresh build material would increase the quality of the printed object, however using recycled build material is an economic incentive.

Some additive manufacturing system may comprise a built-in build material blender or mixer. Build material blenders may mix a quantity of fresh build material with another quantity of recycled build material to supply a substantially homogeneous build material mix to a printing unit to generate a 3D object. Other additive manufacturing units may use a build material processing unit to perform pre and/or post object generation operations. In one example, the additive manufacturing build material processing unit may be part of a separate unit. A transportable build unit transportation unit may be a moveable between a 3D printer and a build material processing unit. In these examples, the blender may be installed in the build material processing unit.

Some examples herein describe systems to enable build material that is generally accepted as being not usable (and therefore should be thrown away) to be used to produce 3D objects that may have some degraded quality parameters compared to an object that may be generated using acceptable recycled build material.

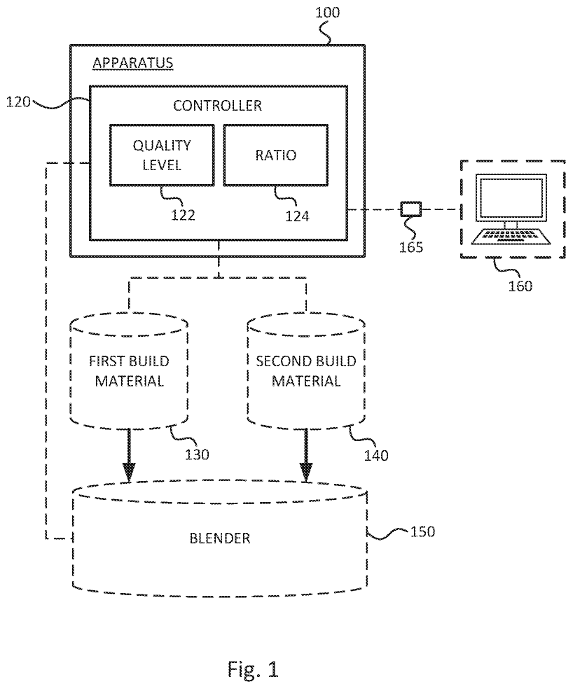

Referring now to the drawings, FIG. 1 is a schematic diagram illustrating an example of an apparatus 100 to prepare a mix of build materials for use in generating a 3D object. The apparatus 100 comprises a controller 120. The term “controller” as used herein may include a series of instructions encoded on a machine-readable storage medium and executable by a single processor or a plurality of processors. Additionally, or alternatively, a controller 120 may include at least one hardware devices including electronic circuitry, for example a digital and/or analog application-specific integrated circuit (ASIC), for implementing the functionality described herein.

The controller 120 may be coupled to some flow control elements, e.g. valves, that enable the controller to control the flow of build material from a first build material container 130 and a second build material container 140. The first build material container 130 comprises a first build material having a first quality level and the second build material container 140 comprises a second build material having a second quality level. The first quality level from the first build material is a higher quality level than the second quality level from the second container. In an example, the first build material is fresh build material and the second build material is recycled build material. In another example, the first build material and the second build material are both recycled build materials, but the second build material may be of a lower quality than the first build material. As mentioned above, the strength of the build material degrades based on the number of recycling cycles the build material experiences. Therefore, a recycled build material that have experienced less recycling cycles may lead to a higher strength printed object than another recycled build material that have experienced more recycling cycles.

The controller 120 may also be coupled to a blender 150. The blender 150 may receive, upon control from the controller 120, an amount of first build material from the first build material container 130, and another amount of the second build material from the second build material container 140. The blender 150 may mix the amount of first build material and the amount of the second build material into a homogeneous build material mix. In some examples, the blender 150 may be implemented as an air blender, a rotating shaft or blade blender, or some other suitable build material blender.

The controller 120 may be coupled to a user interface (UI) 160. A user may transfer data 165 from the UI 160 to the controller 120. In some examples, the UI 160 may be part of a personal computer or desktop computer. In other examples, the UI 160 may be part of a tablet. In yet other examples, the UI 160 may be a handheld electronic device suitable for transferring data to the controller 120, e.g. a smartphone. Some examples of UI have been described, however any device suitable to transfer data packages to the controller 120 may be used without departing from the scope of the present disclosure.

The user may input one or multiple desired quality levels of a 3D object to the UI 160. In some examples, the one or multiple desired quality levels of the 3D object may be included in the print job data, e.g. submitted to the printer through a driver, or being included in some other way. In an example, the quality level may refer to strength parameter if a high-quality 3D object having high object strength is desired. In another example, the quality level may refer to an aesthetic parameter. An aesthetic parameter may include, for example, a surface smoothness, a colour, or the like. In some examples, if the quality level refers to an aesthetic parameter, the high strength of the final object may not be pursued. The UI 160 may send the desired quality level(s) to the controller 120 through, for example, a data package 165. The controller 120 may be to obtain the quality level 122 for the object to be printed based on the input from the UI 160, e.g., data package 165.

The controller 120 may determine a ratio 124 of the first build material from the first build material container 130 and the second build material from the second build material container 140 to be used to prepare a build material mix to be used to generate a 3D object. In an example, the controller may determine the ratio 124 based on the desired quality level 122. In an example, if the desired quality level refers to a strength parameter, the controller 120 may determine the ratio 124 comprising a higher proportion of the first build material from the first build material container 130, e.g. fresh build material. In another example, if the desired quality level is set as an aesthetic parameter, the controller 120 may determine the ratio 124 comprising a higher proportion of second build material from the second build material container 140, e.g. recycled build material. In yet another example, if the desired quality level is set as the medium-quality 3D printing, the controller 120 may determine the ratio 124 comprising an intermediate proportion of first and second build material compared to the strength parameter and the aesthetic parameter.

In one example, the controller 120 may determine the ratio 124 of the first build material from the first build material container 130 and the second build material from the second build material container 140 based in part on the quality of the first build material. In another example, the controller 120 may determine the ratio 124 based in part on the quality of the second build material. In yet another example, the controller 120 may determine the ratio 124 based on the quality of the first build material and the quality of the second build material. Given the same desired quality level 122, if it is determined that the quality of the first build material is somewhat lower than the expected quality of the first build material, the controller 120 may determine the ratio 124 comprising a somewhat higher proportion of first build material. Given the same desired quality level 122, if it is determined that the quality of the second build material is somewhat higher than the expected quality of the second build material, the controller 120 may determine the ratio 124 comprising a somewhat higher proportion of second build material. Given the same desired quality level 122, if it is determined that the quality of the second build material is somewhat lower than the expected quality of the second build material, the controller 120 may determine the ratio 124 comprising a somewhat higher proportion of first build material.

The controller 120 may control some flow control elements, e.g. valves, that enable the controller to control the flow of build material from the first build material container 130, the second build material container 140, and/or blender 150 to prepare the mix of build material based on the determined ratio 124 to be used during the generation of the object. For example, the controller 130 may control some flow control elements to control the flow of build material from the first build material container 130 to supply a predetermined amount of first build material to the blender 150 and may control the flow control elements to control the flow of build material from the second build material container 140 to supply a predetermined amount of second build material to the blender 150 in accordance with the ratio 124. The controller 120 may control the blender 150 to mix the build material therein into a substantially homogeneous build material mix.

The examples described the first build material container 130 and second build material container 140 are not part of the apparatus 100. However, in one example the apparatus 100 may comprise one or more of the first build material container 130, the second build material container 140, the blender 150, and the UI 160.

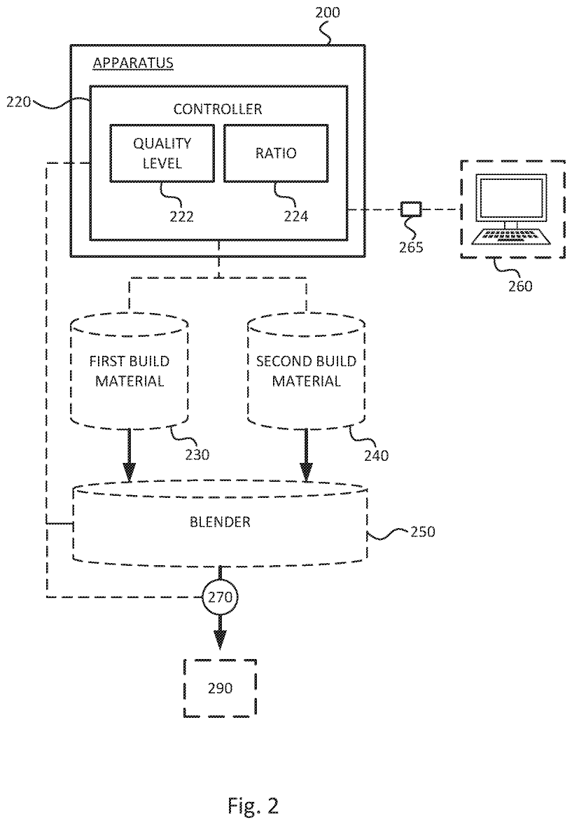

FIG. 2 is a schematic diagram illustrating an example of an apparatus 200 to prepare mix of build materials. The apparatus 200 may be similar to the apparatus 100 from FIG. 1. The apparatus 200 may comprise a controller 220 to perform at least the same operations as the controller 120 from FIG. 1.

The controller 220 may be to obtain the desired quality level 222 through a data package 265 received from a UI 260. In some examples, the desired quality level 222 of the 3D object may be included in the print job data, e.g. submitted to the printer through a driver, or being included in some other way. The data package 265 and the UI 260 may be the same as or similar to the data package 165 and the UI 160 from FIG. 1. The controller 220 may be coupled to a first build material container 230 comprising first build material therein, and to a second build material container 240 comprising second build material therein. The first build material quality may be a higher quality build material than the second build material quality. The first build material container 230, the first build material, the second build material container 240, and the second build material, may be the same as or similar to the first build material container 130, the first build material, the second build material container 140, and the second build material from FIG. 1. The controller 220 may also be coupled to a blender 250. The blender 250 may be the same as or similar to the blender 150 from FIG. 1.

The blender 250 may be connected or connectable to a device 290. The blender 250 may be to supply the bended build material mix to the device 290. In an example, the device 290 is a three-dimensional printer. In another example, the device 290 is a build material processing unit.

In some examples, a sensor 270 may be provided to measure the quality of the build material mix supplied from the blender 250. In an example, the sensor 270 may be placed within the blender. In another example, the sensor 270 may be placed in the build material connecting path between the blender 250 and the device 290. The sensor 270 may be coupled to the controller 220. The sensor 270 may measure the quality of the build material mix from the blender 250 through measuring a parameter. An example of the parameter may be a color parameter and the sensor 270 may be any color sensor, or photosensor. Another example of the parameter may be the Melt Flow Index (MFI) and the sensor 270 may be any viscosity measuring mechanism that measures the viscosity of the mix of build materials and derive the MFI therefrom.

As mentioned above, any non-fused, or non-solidified, build material may be recycled for subsequent layers and/or subsequent print jobs. However, recycled build material may have properties or characteristics, e.g. strength, which are inferior to fresh build material. Consequently, objects generated with recycled build material may have inferior object properties compared to objects generated with fresh build material. With some build materials, the quality of the build material may be visually determined by the color of the build material. In an example, the quality of the build material may be defined by three groups of build material status: (i) fresh build material, (ii) degraded but acceptable build material, and (iii) degraded but unacceptable build material.

‘Fresh build material’ should be understood as the build material that is not degraded, and that exhibits its original properties and/or characteristics. For example, fresh build material may have white or similar colour. For example, fresh PA12 build material has a generally white colour. Degraded but acceptable build material should be understood as the build material that is slightly degraded, and that may have lost some of its initial properties and/or characteristics. For example, degraded but acceptable build material color may have yellow or similar colour. For example, degraded but acceptable PA12 build material has a generally yellow colour. Degraded but unacceptable (referred hereinafter as “degraded build material”) should be understood as the build material that has a high level of oxidation and has properties or characteristics that are deemed generally unacceptable for use in 3D printing. In an example, degraded build material color may have a brown or similar colour. For example, degraded PA12 has a generally brown colour. The relationship between colour and quality may be based on test results for a particular build material, e.g. PA12, and may be stored in a look-up table. Therefore, by measuring the color of the build material mix from the blender 250, the controller may determine the quality of the build material mix from the blender 250.

As mentioned above, the MFI may be another measurable parameter indicative of the quality of the build material mix from the blender 250. The MFI is a measure of the ease of flow of melted build material, such as a thermoplastic polymer build material. The MFI may also be indicative of the degradation stage of a given build material since it can be used to determine whether a build material is degraded beyond a desired amount. The MFI may be defined as the mass of polymer, in grams, flowing through a die in ten minutes, at a given temperature based on the polymer and under certain conditions. The MFI conditions are described in the standard ASTM D1238 and ISO 1133. The MFI of a build material may change depending on the degradation point of the build material; e.g., fresh build material, degraded but acceptable build material, degraded but unacceptable build material. Fresh MFI may reside at an initial MFI value of, for example, about 30-35 grams per 10 minutes in PA12. The initial MFI value may be known based on prior testing. After having been through multiple recycling cycles, the build material may start to degrade which may cause a change in the MFI down to a minimum MFI after which it may stay generally constant. In an example, PA12 build material may have a minimum MFI of about 20 grams per 10 minutes. After being used in multiple recycling cycles, the build material may continue degrading and its MFI may increase up to the about 30-35 grams per 10 minutes. From that point, and upon more recycling cycles, the build material may start the degradation, i.e. unacceptable quality for object generation, stage increasing its MFI exponentially; e.g., more than about 35 grams per 10 minutes in PA12. Therefore, by measuring the MFI of the build material mix from the blender 250, the controller may determine the quality of the build material mix from the blender 250.

The controller 220 may control the sensor 270 to measure a parameter, e.g. color and/or MFI, from the mix of the first build material and second build material. The controller 220 may compare the measured parameter with a parameter threshold. The parameter threshold may indicate whether the stage of degradation of the mix of build material is compliant with the desired quality level 222. The controller 220 may determine the parameter threshold upon obtaining the desired quality level 222. In an example, if it is determined that the desired quality level 222 refers to a strength parameter, the parameter threshold may be selected as a strict parameter threshold. In another example, if it is determined that the desired quality level 222 refers to an aesthetic parameter, the parameter threshold may be selected as a lenient parameter threshold, therefore allowing lower quality build material mixes as acceptable.

The controller 220 may modify the ratio 224 of the first build material and the second build material based on the parameter comparison between the measured parameter with the parameter threshold.

For example, if it is determined that the measured parameter exceeds the parameter threshold by a predetermined amount, it may be indicative that the build material mix quality is substantially higher than the build material quality level 222. In the example, the controller 220 may modify the ratio 224 by increasing the proportion of second build material from the second build material container 240 to use additional recycling build material and still meet the quality level 222.

In another example, if it is determined that the measured parameter is below the parameter threshold by a predetermined amount, it may be indicative that the build material mix quality does not meet the build material quality level 222. In this case the controller 220 may modify the ratio 224 by increasing the proportion of first build material from the first build material container 230 to increase the quality of the build material mix in the blender 250 so that it meets the quality level 222. In one example, the controller 220 may select the increase of the proportion of first build material based on the difference between the measured parameter and the parameter threshold. In an example, if the difference between the measured parameter and the parameter threshold is small, the controller 220 may slightly increase the proportion of first build material in the build material mix from the blender 250. In another example, if the difference between the measured parameter and the parameter threshold is big, the controller 220 may substantially increase the proportion of first build material in the build material mix in the blender 250. The previous could be an iterative process until the quality of the mix is acceptable to build the 3D object.

In an example, the controller 220 may further instruct the blender 250 to supply at least part of the build material mix therein to the device 290.

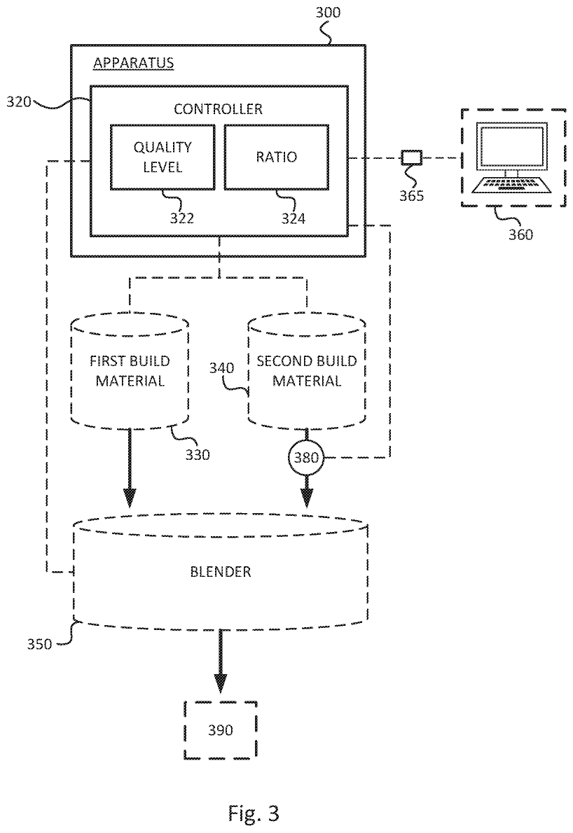

FIG. 3 is a schematic diagram illustrating an example of another apparatus 300 to prepare mix of build materials. The apparatus 300 may be similar to the apparatus 100 from FIG. 1. The apparatus 300 may comprise a controller 320 to perform at least the same operations as the controller 120 from FIG. 1.

The controller 320 may be to obtain the desired quality level 322 through a data package 365 received from a UI 360. In some examples, the desired quality level 322 of the 3D object may be included in the print job data, e.g. submitted to the printer through a driver, or being included in some other way. The data package 365 and the UI 360 may be the same as or similar to the data package 165 and the UI 160 from FIG. 1. The controller 320 may be coupled to a first build material container 330 comprising first build material therein, and to a second build material container 340 comprising second build material therein. The first build material quality may be a higher quality build material than the second build material quality. The first build material container 330, the first build material, the second build material container 340, and the second build material, may be the same as or similar to the first build material container 130, the first build material, the second build material container 140, and the second build material from FIG. 1. The controller 320 may also be coupled to a blender 350. The blender 350 may be the same as or similar to the blender 150 from FIG. 1.

The blender 350 may be connected or connectable to a device 390. The blender 350 may be to supply the bended build material mix to the device 390. In an example, the device 390 is a three-dimensional printer. In another example, the device 390 is a build material processing unit.

As mentioned above, the first build material container 330 and the second build material container 340 may supply an amount of first build material and second build material respectively based on a ratio 324 determined by the controller 320. The ratio 324 of the first build material and second build material may be selected based on the quality level 322, the quality of the first build material, and/or the quality of the second build material. Some examples comprise fresh build material as the first build material and recycled build material as the second build material. In these examples, the quality of the first build material is known, however the quality of the second build material may vary depending on the recycling cycles the second build material have experienced.

The controller 320 may be coupled to a sensor 380. Sensor 380 may be the same sensor as or a similar sensor to sensor 270 from FIG. 2. Sensor 380 may be provided to measure the quality of the second build material from the second build material container 340. In an example, the sensor 380 may be placed within the second build material container 340. In another example, the sensor 380 may be placed in the build material connecting path between the second build material container 340 and the blender 350. The sensor 380 may measure the quality of the second build material from the second build material container 340 through a measuring parameter. The measuring parameter may be the same as or similar to the measuring parameter described with reference to FIG. 2. An example of the parameter may be a color parameter and the sensor 380 may be any color sensor, or photosensor (see, e.g., FIG. 2). Another example of the parameter may be the Melt Flow Index (MFI) and the sensor 380 may be any viscosity measuring mechanism that measures the viscosity of the second build material and derive the MFI therefrom.

The controller 320 may control the sensor 380 to measure the parameter of the second build material from the second build material container 340, e.g. color and/or MFI. The controller 320 may be also to compare the measured parameter with a second build material parameter threshold. The second build material parameter threshold may indicate how degraded is the second build material with respect to the expected degradation value of the second build material. In an example, the second build material parameter threshold may be selected based on the desired quality level 322. In an example, if it is determined that the desired quality level 322 refers to a strength parameter, the second build material parameter threshold may be selected as a strict parameter threshold. In another example, if it is determined that the desired quality level 322 refers to an aesthetic parameter, the second build material parameter threshold may be selected as a lenient parameter threshold, therefore allowing lower quality second build materials as acceptable.

The controller 320 may modify the ratio 324 of the first build material and the second build material based on the second build material parameter comparison between the measured parameter of the second build material with the second build material parameter threshold.

For example, if it is determined that the measured parameter exceeds the second build material parameter threshold by a predetermined amount, it may be indicative that the second build material quality is substantially higher than the expected second build material quality. In the example, the controller 320 may modify the ratio 324 by increasing the proportion of second build material from the second build material container 340, therefore using additional recycling build material and still meet the quality level 322 in the mix of build materials from the blender 350.

In another example, if it is determined that the measured parameter is below second build material parameter threshold by a predetermined amount, it may be indicative that the second build material quality is below the expected second build material quality. In the example, the controller 320 may modify the ratio 324 by increasing the proportion of first build material from the first build material container 330 to increase the quality of the build material mix in the blender 350 and therefore meet the quality level 322. Additionally, the controller 320 may select the proportion of first build material increase based on the difference between the measured parameter and the second build material parameter threshold. In an example, if the difference between the measured parameter and the second build material parameter threshold is small, the controller 320 may slightly increase the proportion of first build material in the build material mix in the blender 350. In another example, if the difference between the measured parameter and the parameter threshold is substantially big, the controller 320 may substantially increase the proportion of first build material in the build material mix from the blender 350.

In an example, the controller 320 may further instruct the blender 350 to supply at least part of the build material mix therein to the device 390.

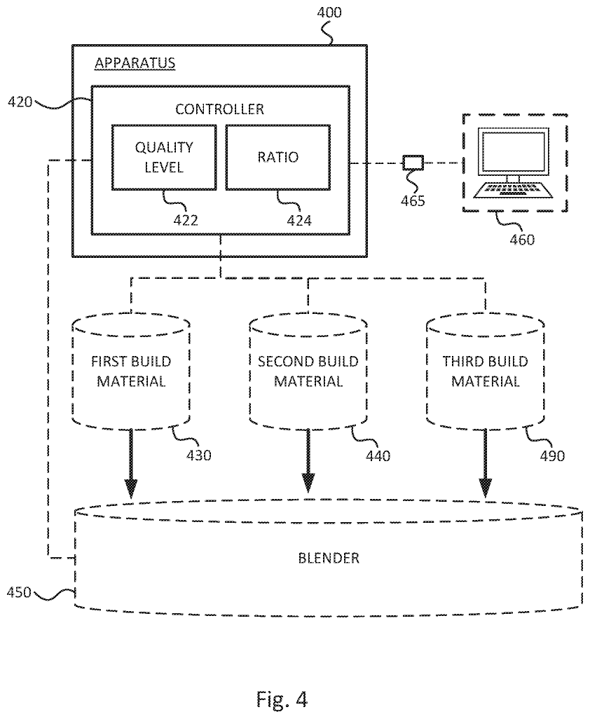

FIG. 4 is a schematic diagram illustrating an example of another apparatus 400 to prepare mix of build materials. The apparatus 400 may be similar to the apparatus 100 from FIG. 1. The apparatus 400 may comprise a controller 420 to perform at least the same operations as the controller 120 from FIG. 1.

The controller 420 may be to obtain the desired quality level 422 through a data package 465 received from a UI 460. In some examples, the desired quality level 422 of the 3D object may be included in the print job data, e.g. submitted to the printer through a driver, or being included in some other way. The data package 465 and the UI 460 may be the same as or similar to the data package 165 and the UI 160 from FIG. 1. The controller 420 may be coupled to a first build material container 430 comprising first build material therein, to a second build material container 440 comprising second build material therein, and to a third build material container 490 comprising third build material therein. The first build material quality may be a higher quality build material than the second build material quality. The second build material quality may be a higher quality build material than the third build material quality. The first build material container 430, the first build material, the second build material container 440, and the second build material, may be the same as or similar to the first build material container 130, the first build material, the second build material container 140, and the second build material from FIG. 1. The controller 420 may also be coupled to a blender 450. The blender 450 may be the same as or similar to the blender 150 from FIG. 1.

In an example, the first build material may be fresh build material. In another example, the second build material may be degraded but acceptable build material, i.e. suitable to generate an object. In another example, the third build material may be degraded build material, i.e. degraded but unacceptable build material. In the example, the third build material has a quality level which is unsuitable by itself for use in generating the object. In yet another example, the first build material may be fresh build material, the second build material may be degraded but acceptable build material, and the third build material may be degraded build material. See, e.g., a more detailed description of the different build material quality levels with reference to FIG. 2.

The controller 420 may determine the ratio 424 of the first build material, the second build material, and the third build material based on the desired quality level 422. The ratio 424 may determine the proportion and/or amount of first build material, the proportion and/or amount of second build material, and the proportion/amount of third build material to be supplied in the blender 450 to generate a build material mix.

In an example, if it is determined that the desired quality level 422 refers to a strength parameter, the controller 420 may determine a ratio 424 comprising a substantially higher proportion and/or amount of first build material with respect to the second and third build materials. In another example, if it is determined that the desired quality level 422 refers to a medium-quality parameter, the controller 420 may determine a ratio 424 comprising a substantially higher proportion and/or amount of second build material with respect to the first and third build materials. In yet another example, if it is determined that the desired quality level 422 refers to an aesthetic parameter, the controller 420 may determine a ratio 424 comprising a substantially higher proportion and/or amount of third build material with respect to the first and second build materials. These are examples of build material usages in the ratio 424 based on the desired quality level 422, however any combination of build materials amounts may apply without departing from the scope of the present disclosure.

The controller 420 may also control some flow control elements, e.g. valves, that enable the controller to control the flow of build material from the first build material container 430, the second build material container 440, the third build material container 490, and the blender 450 to prepare a mix of build materials based on the determined ratio 424. The controller 420 may control the flow control elements to control the flow of build material from the first build material container 430 to supply an amount of first build material to the blender 450 based on the determined ratio 424. The controller 420 may control the flow control elements to control the flow of build material from the second build material container 440 to supply an amount of second build material to the blender 450 based on the determined ratio 424. The controller 420 may control flow control elements to control the flow of build material from the third build material container 490 to supply an amount of third build material to the blender 450 based on the determined ratio 424. The controller 420 may control the blender 450 to mix the build materials therein to obtain the mix of build materials. In some examples, the amount of build material of any particular build material container may be zero.

The previous example describes an apparatus 400 to prepare a mix of build materials taking into account a desired quality level 422. If the final build material mix is compliant with the desired quality level 422, the example contemplates the addition of an amount of third build material which is unsuitable to generate an object by itself.

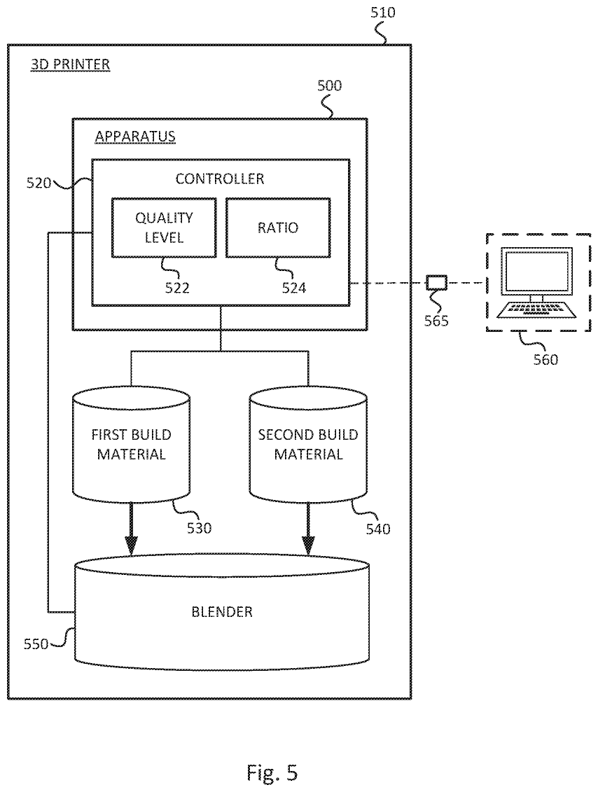

FIG. 5 is a schematic diagram illustrating an example of a 3D printer 510 comprising an apparatus 500 to prepare mix of build materials. The apparatus 500 may be similar to the apparatus 100 from FIG. 1. The apparatus 500 may comprise a controller 520 to perform at least the same operations as controller 120 from FIG. 1.

The controller 520 may be to obtain the desired quality level 522 through a data package 565 received from a UI 560. The data package 565 and the UI 560 may be the same as or similar to the data package 165 and the UI 160 from FIG. 1. The controller 520 may be coupled to a first build material container 530 comprising first build material therein, and to a second build material container 540 comprising second build material therein. The first build material quality may be a higher quality build material than the second build material quality. The first build material container 530, the first build material, the second build material container 540, and the second build material, may be the same as or similar to the first build material container 130, the first build material, the second build material container 140, and the second build material from FIG. 1. The controller 520 may also be coupled to a blender 550. The blender 550 may be the same as or similar to the blender 150 from FIG. 1.

The controller 520 is to determine a ratio 524 of the first build material and second build material based on the desired quality level 522. The controller 520 is to control the blender 550 to prepare a mix of build material of the determined ratio to be used during the generation of the object. The controller 520 may further control the blender 550 to supply the mix of build material to a layering mechanism of the 3D printer (not shown). The layering mechanism may be to supply build material layers to the printing bed to generate the layers of the object.

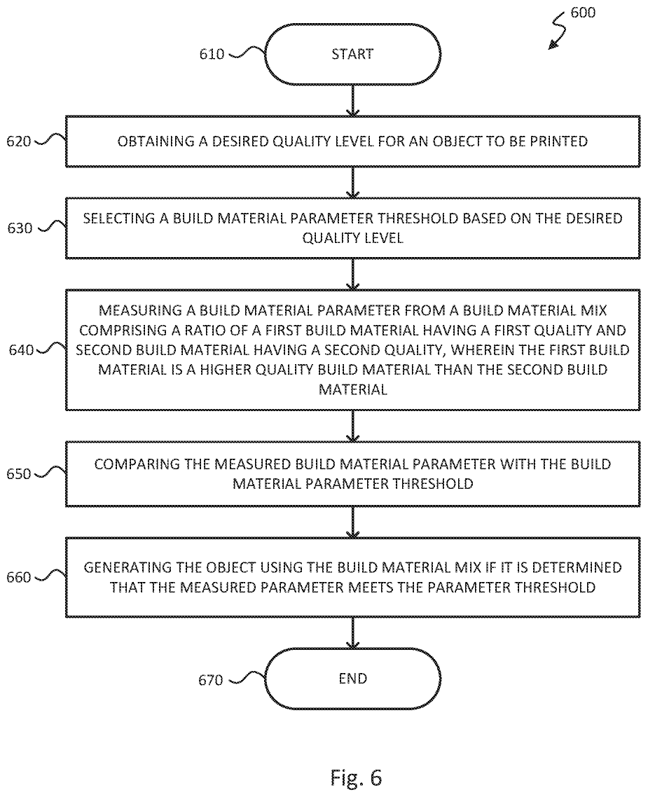

FIG. 6 is a flowchart of an example method 600 for preparing a mix of build materials. Method 600 may be described below as being executed or performed by an apparatus, such as apparatus 100 of FIG. 1. Various other suitable apparatuses may be used as well, such as, for example apparatus 200 of FIG. 2, apparatus 300 from FIG. 3, apparatus 400 from FIG. 4, and 3D printer 510 from FIG. 5. Method 600 may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 600 may include more or less blocks than are shown in FIG. 6. In some implementations, at least one of the blocks of method 600 may, at certain times, be performed in parallel and/or may repeat.

Method 600 may start at block 610, and continue to block 620, where a controller may obtain a desired quality level for an object to be printed. At block 630, the controller may select a build material parameter threshold based on the desired quality level. At block 640, the controller may measure a build material parameter from a build material mix comprising a ratio of a first build material having a first quality and second build material having a second quality. The first build material is a higher build material than the second build material. At block 650, the controller may compare the measured build material parameter with the build material parameter threshold. At block 660, if it is determined that the measured parameter meets the parameter threshold, a 3D printer may generate the object using the build material mix. At block 670, method 600 may end.

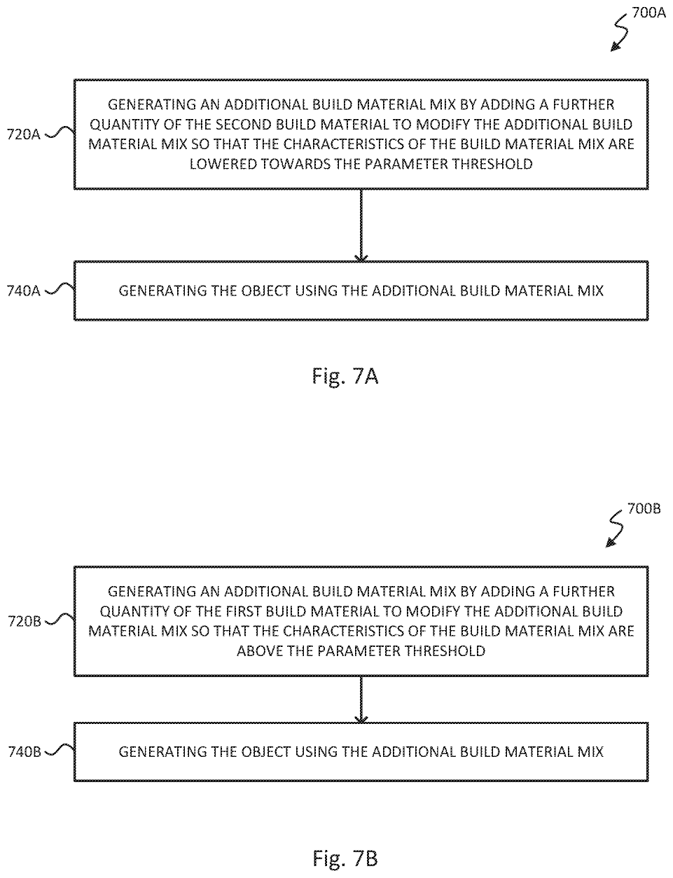

FIG. 7A is a flowchart of another example method 700A for preparing a mix of build materials. Method 700A may be performed after block 650 from FIG. 6 where it has been determined that the measured parameter exceeds the parameter threshold by a predetermined amount. Method 700A may be executed or performed by an apparatus, such as apparatus 100 of FIG. 1. Various other suitable apparatuses may be used as well, such as, for example apparatus 200 of FIG. 2, apparatus 300 from FIG. 3, apparatus 400 from FIG. 4, and 3D printer 510 from FIG. 5. Method 700A may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 700A may include more or less blocks than are shown in FIG. 7A. In some implementations, at least one of the blocks of method 700A may, at certain times, be performed in parallel and/or may repeat.

Method 700A may comprise a plurality of operations to be performed, for example, operations corresponding to block 720A and block 740A. At block 720A, the controller may generate an additional build material mix by adding a further quantity of the second build material to modify the additional build material mix so that the characteristics of the build material mix are lowered towards the parameter threshold. At block 740A, a 3D printer may generate the object using the additional build material mix. Then, method 700A may end.

FIG. 7B is a flowchart of another example method for preparing a mix of build materials. Method 700B may be performed after block 650 from FIG. 6 where it has been determined that the measured parameter is below the parameter threshold by a predetermined amount. Method 700B may be described below as being executed or performed by an apparatus, such as apparatus 100 of FIG. 1. Various other suitable apparatuses may be used as well, such as, for example apparatus 200 of FIG. 2, apparatus 300 from FIG. 3, apparatus 400 from FIG. 4, and 3D printer 510 from FIG. 5. Method 700B may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 700B may include more or less blocks than are shown in FIG. 7B. In some implementations, at least one of the blocks of method 700B may, at certain times, be performed in parallel and/or may repeat.

Method 700B may comprise a plurality of operations to be performed, for example, operations corresponding to block 720B and block 740B. At block 720B, the controller may generate an additional build material mix by adding a further quantity of the first build material to modify the additional build material mix so that the characteristics of the build material mix are above the parameter threshold. At block 740B, a 3D printer may generate the object using the additional build material mix. Then, method 700A may end.

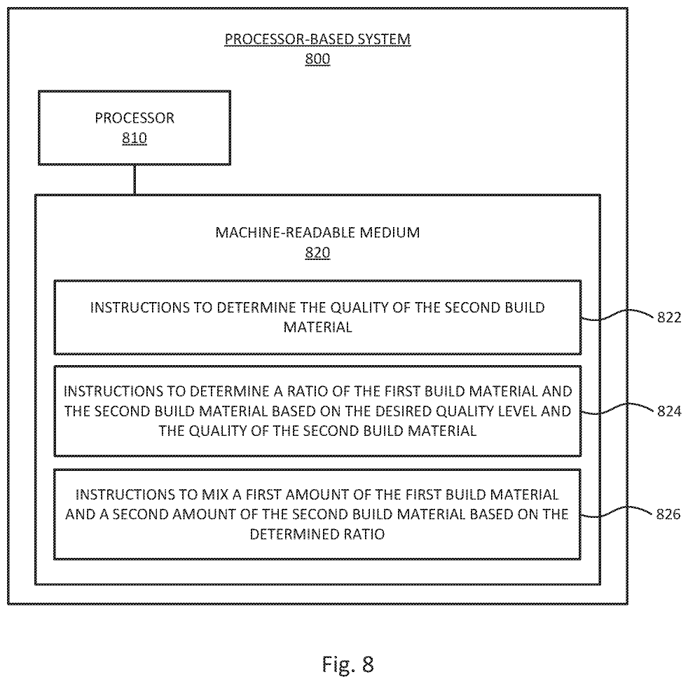

FIG. 8 is a schematic diagram illustrating an example of a processor-based system 800 to prepare mix of build materials. In some implementations, the system 800 may be or may form part of an apparatus, e.g. apparatus 100 from FIG. 1. In some implementations, the system 800 is a processor-based system and may include a processor 810 coupled to a machine-readable medium 820. The processor 810 may include a single-core processor, a multi-core processor, an application-specific integrated circuit (ASIC), a field programmable gate array (FPGA), and/or any other hardware device suitable for retrieval and/or execution of instructions from the machine-readable medium 820 (e.g., instructions 822-826) to perform functions related to various examples. Additionally, or alternatively, the processor 810 may include electronic circuitry for performing the functionality described herein, including the functionality of instructions 822-826. With respect of the executable instructions represented as boxes in FIG. 8, it should be understood that part or all of the executable instructions and/or electronic circuits included within one box may, in alternative implementations, be included in a different box shown in the figures or in a different box not shown.

The machine-readable medium 820 may be any medium suitable for storing executable instructions, such as a random-access memory (RAM), electrically erasable programmable read-only memory (EEPROM), flash memory, hard disk drives, optical disks, and the like. In some example implementations, the machine-readable medium 820 may be a tangible, non-transitory medium, where the term “non-transitory” does not encompass transitory propagating signals. The machine-readable medium 820 may be disposed within the processor-based system 800, as shown in FIG. 8, in which case the executable instructions may be deemed “installed” on the system 800. Alternatively, the machine-readable medium 820 may be a portable, e.g., external, storage medium, for example, that allows system 800 to remotely execute the instructions or download the instructions from the storage medium. In this case, the executable instructions may be part of an “installation package”. As described further herein below, the machine-readable medium may be encoded with a set of executable instructions 822-826.

The medium 820 is to receive a desired quality level for an object to be printed using a mix of a higher quality first build material and a lower quality second build material. The medium 820 comprise the above-mentioned set of executable instructions 822-826. Instructions 822, when executed by the processor 810, may cause the processor 810 to determine the quality of the second build material. Instructions 824, when executed by the processor 810, may cause the processor 810 to determine a ratio of the first build material and the second build material based on the desired quality level and the quality of the second build material. Instructions 826, when executed by the processor 810, may cause the processor 810 to mix a first amount of the first build material and a second amount of the second build material based on the determined ratio.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

As used herein, the term “about”, “approximately”, and “substantially” are used to provide flexibility to a numerical range endpoint by providing that a given value may be, for example, an additional 20% more or an additional 20% less than the endpoints of the range. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

Example implementations can be realized according to the following clauses:

Clause 1: An apparatus comprising a controller to: (i) obtain a desired quality level for an object to be printed based on an input; (ii) determine a ratio of a first build material and a second build material based on the desired quality level, wherein the first build material is a higher quality build material than the second build material; and (iii) prepare a mix of build material of the determined ratio to be used during the generation of the object.

Clause 2: The apparatus of clause 1, wherein the controller is further to: (i) measure a parameter from the mix of the first and second build materials; (ii) compare the measured parameter with a parameter threshold, wherein the parameter threshold is selected based on the desired quality level; and (iii) modify the ratio of the first build material and the second build material based on the parameter comparison between the measured parameter with the parameter threshold.

Clause 3: The apparatus of any preceding clause, wherein the parameter is at least one of a color parameter and/or a Melt Flow Index (MFI).

Clause 4: The apparatus of any preceding clause, wherein the parameter is a MFI, the controller is further to: (i) instruct a viscosity measuring mechanism to measure the viscosity of the build material mix; and (ii) obtain the MFI based on the measured build material mix viscosity.

Clause 5: The apparatus of any preceding clause, wherein the first build material is fresh build material and the second build material is a previously used build material.

Clause 6: The apparatus of any preceding clause, being included in a three-dimensional printer.

Clause 7: The apparatus of any preceding clause, wherein the controller is further to: (i) determine the ratio of the first build material, the second build material, and a third build material based on the desired quality level, wherein the second build material is a higher quality build material than the third build material; and (ii) prepare a mix of build materials based on the determined ratio, wherein the mix comprises a first amount of the first build material, a second amount of the second build material, and/or a third amount of the third build material.

Clause 8: The apparatus of any preceding clause, wherein the second build material has a quality level which is unsuitable by itself for use in generating the object.

Clause 9: The apparatus of any preceding clause, wherein the controller is further to supply at least part of the mix to at least one of a three-dimensional printer and/or a build material processing unit.

Clause 10: the apparatus of any preceding clause, wherein the ratio of the first build material and the second build material are further selected based on the quality of the first build material, and/or the quality of the second build material.

Clause 11: The apparatus of any preceding clause, wherein the controller is further to: (i) measure a parameter of the second build material; (ii) compare the measured parameter with a second build material parameter threshold, wherein the second build material parameter threshold is selected based on the desired quality level; and (iii) modify the ratio of the first build material and the second build material based on the parameter comparison between the measured parameter of the second build material with the second build material parameter threshold.

Clause 12: A method comprising: (i) obtaining a desired quality level for an object to be printed; (ii) selecting a build material parameter threshold based on the desired quality level; (iii) measuring a build material parameter from a build material mix comprising a ratio of a first build material having a first quality and second build material having a second quality, wherein the first build material is a higher quality build material than the second build material; (iv) comparing the measured build material parameter with the build material parameter threshold; and (v) generating the object using the build material mix if it is determined that the measured parameter meets the parameter threshold.

Clause 13: The method of clause 12, wherein the measured parameter exceeds the parameter threshold by a predetermined amount, the method further comprising: (i) generating an additional build material mix by adding a further quantity of the second build material to modify the additional build material mix so that the characteristics of the build material mix are lowered towards the parameter threshold; and (ii) generating the object using the additional build material mix.

Clause 14: The method of clause 12, wherein the measured parameter is below the parameter threshold by a predetermined amount, the method further comprising: (i) generating an additional build material mix by adding a further quantity of the first build material to modify the additional build material mix so that the characteristics of the build material mix are above the parameter threshold; and (ii) generating the object using the additional build material mix.

Clause 15: A non-transitory machine-readable medium storing instructions executable by a processor, wherein the medium is to receive a desired quality level for an object to be printed using a mix of a higher quality first build material and a lower quality second build material, the non-transitory machine-readable medium comprising: (i) instructions to determine the quality of the second build material; (ii) instructions to determine a ratio of the first build material and the second build material based on the desired quality level and the quality of the second build material; and (iii) instructions to mix a first amount of the first build material and a second amount of the second build material based on the determined ratio.

What it is claimed is:

1. An apparatus comprising:
a controller to:
obtain a desired quality level for an object to be printed based on an input;
determine a ratio of a first build material and a second build material based on the desired quality level, wherein the first build material is a higher quality build material than the second build material; and
prepare a mix of build material of the determined ratio to be used during the generation of the object.

2. The apparatus of claim 1, wherein the controller is further to:
measure a parameter from the mix of the first and second build materials;
compare the measured parameter with a parameter threshold, wherein the parameter threshold is selected based on the desired quality level; and
modify the ratio of the first build material and the second build material based on the parameter comparison between the measured parameter with the parameter threshold.

3. The apparatus of claim 2, wherein the parameter is at least one of a color parameter and/or a Melt Flow Index (MFI).

4. The apparatus of claim 3, wherein the parameter is a MFI, the controller is further to:
instruct a viscosity measuring mechanism to measure the viscosity of the build material mix; and
obtain the MFI based on the measured build material mix viscosity.

5. The apparatus of claim 1, wherein the first build material is fresh build material and the second build material is a previously used build material.

6. The apparatus of claim 1, being included in a three-dimensional printer.

7. The apparatus of claim 1, wherein the controller is further to:
determine the ratio of the first build material, the second build material, and a third build material based on the desired quality level, wherein the second build material is a higher quality build material than the third build material; and
prepare a mix of build materials based on the determined ratio, wherein the mix comprises a first amount of the first build material, a second amount of the second build material, and/or a third amount of the third build material.

8. The apparatus of claim 1, wherein the second build material has a quality level which is unsuitable by itself for use in generating the object.

9. The apparatus of claim 1, wherein the controller is further to supply at least part of the mix to at least one of a three-dimensional printer and/or a build material processing unit.

10. The apparatus of claim 1, wherein the ratio of the first build material and the second build material are further selected based on the quality of the first build material, and/or the quality of the second build material.

11. The apparatus of claim 1, wherein the controller is further to:
measure a parameter of the second build material;
compare the measured parameter with a second build material parameter threshold, wherein the second build material parameter threshold is selected based on the desired quality level; and
modify the ratio of the first build material and the second build material based on the parameter comparison between the measured parameter of the second build material with the second build material parameter threshold.

12. A method comprising:
obtaining a desired quality level for an object to be printed;
selecting a build material parameter threshold based on the desired quality level;
measuring a build material parameter from a build material mix comprising a ratio of a first build material having a first quality and second build material having a second quality, wherein the first build material is a higher quality build material than the second build material;
comparing the measured build material parameter with the build material parameter threshold; and
generating the object using the build material mix if it is determined that the measured parameter meets the parameter threshold.

13. The method of claim 12, wherein the measured parameter exceeds the parameter threshold by a predetermined amount, the method further comprising:
generating an additional build material mix by adding a further quantity of the second build material to modify the additional build material mix so that the characteristics of the build material mix are lowered towards the parameter threshold; and
generating the object using the additional build material mix.

14. The method of claim 12, wherein the measured parameter is below the parameter threshold by a predetermined amount, the method further comprising:
generating an additional build material mix by adding a further quantity of the first build material to modify the additional build material mix so that the characteristics of the build material mix are above the parameter threshold; and
generating the object using the additional build material mix.

15. A non-transitory machine-readable medium storing instructions executable by a processor, wherein the medium is to receive a desired quality level for an object to be printed using a mix of a higher quality first build material and a lower quality second build material, the non-transitory machine-readable medium comprising:
instructions to determine the quality of the second build material;
instructions to determine a ratio of the first build material and the second build material based on the desired quality level and the quality of the second build material; and
instructions to mix a first amount of the first build material and a second amount of the second build material based on the determined ratio.
